(19) United States
(12) Patent Application Publication
(10) Pub. No.: US 2023/0147561 A1
(43) Pub. Date: May 11, 2023

(54) Metaverse Content Modality Mapping

(71) Applicant: Niantic, Inc., San Francisco, CA (US)

(72) Inventors: Erik Murphy-Chutorian, Palo Alto, CA (US); Nicholas Butko, Cupertino, CA (US); Thomas Emrich, San Francisco, CA (US); Joel Udwin, Mountain View, CA (US); Rigel Gareth Benton, Mountain View, CA (US); Christoph Michael Bartschat, Mountain View, CA (US)

(21) Appl. No.: 17/982,365

(22) Filed: Nov. 7, 2022

Related U.S. Application Data
(60) Provisional application No. 63/277,163, filed on Nov. 8, 2021.

(51) Int. Cl. G06F 3/04815; G06T 17/00; G06F 3/04883; G02B 27/01

(52) U.S. Cl. CPC G06F 3/04815; G02B 27/0172; G06F 3/04883; G06T 17/00

(57) ABSTRACT

Implementations generally relate to metaverse content modality mapping. In some implementations, a method includes obtaining functionality developed for a first modality of a virtual environment. The method further includes mapping the functionality to a second modality of the virtual environment. The method further includes executing the functionality developed for the first modality based on user interaction associated with the second modality.

### CROSS REFERENCE TO RELATED APPLICATIONS

This application claims priority from U.S. Provisional Pat. Application No. 63/277,163, entitled “REALITY ENGINE,” filed Nov. 8, 2021, which is hereby incorporated by reference as if set forth in full in this application for all purposes.

### BACKGROUND

Metaverse content is an interactive experience where a system presents objects in a virtual- or real-world environment with computer-generated objects. Metaverse content may be presented in different modalities such as mobile phone augmented reality (AR), on headset AR or virtual reality (VR), on a two-dimensional (2D) display (e.g., on a desktop computer), etc. Metaverse content may be displayed on an app or mobile browser. A barrier to metaverse content development is the need to handle multiple modalities.

### SUMMARY

Implementations generally relate to metaverse content modality mapping. In some implementations, a system includes one or more processors, and includes logic encoded in one or more non-transitory computer-readable storage media for execution by the one or more processors. When executed, the logic is operable to cause the one or more processors to perform operations including: obtaining functionality developed for a first modality of a virtual environment; mapping the functionality to a second modality of the virtual environment; and executing the functionality developed for the first modality based on user interaction associated with the second modality.

With further regard to the system, in some implementations, the first modality is associated with augmented reality of a first device type, wherein the first device type is a mobile device, wherein the second modality is associated with a second device type, and wherein the second device type is one of an augmented reality headset, a virtual reality headset, or a desktop computer. In some implementations, the logic when executed is further operable to cause the one or more processors to perform operations comprising: determining a device associated with the second modality; activating software modules associated with the second modality; and adapting user interaction with the device to the functionality developed for the first modality. In some implementations, the logic when executed is further operable to cause the one or more processors to perform operations comprising mapping one or more user gestures in a three-dimensional scene associated with the second modality to one or more two-dimensional user interface elements associated with the first modality. In some implementations, the logic when executed is further operable to cause the one or more processors to perform operations comprising mapping user interaction with one or more input devices associated with the second modality to one or more two-dimensional user interface elements associated with the first modality. In some implementations, the logic when executed is further operable to cause the one or more processors to perform operations comprising adapting one or more background elements in a three-dimensional scene associated with the second modality based on a device type associated with the second modality. In some implementations, the logic when executed is further operable to cause the one or more processors to perform operations comprising adapting at least one target object in a three-dimensional scene associated with the second modality based on a device type associated with the second modality.

In some implementations, a non-transitory computer-readable storage medium with program instructions thereon is provided. When executed by one or more processors, the instructions are operable to cause the one or more processors to perform operations including: obtaining functionality developed for a first modality of a virtual environment; mapping the functionality to a second modality of the virtual environment; and executing the functionality developed for the first modality based on user interaction associated with the second modality.

With further regard to the computer-readable storage medium, in some implementations, the first modality is associated with augmented reality of a first device type, wherein the first device type is a mobile device, wherein the second modality is associated with a second device type, and wherein the second device type is one of an augmented reality headset, a virtual reality headset, or a desktop computer. In some implementations, the logic when executed is further operable to cause the one or more processors to perform operations comprising: determining a device associated with the second modality; activating software modules associated with the second modality; and adapting user interaction with the device to the functionality developed for the first modality. In some implementations, the instructions when executed are further operable to cause the one or more processors to perform operations comprising mapping one or more user gestures in a three-dimensional scene associated with the second modality to one or more two-dimensional user interface elements associated with the first modality. In some implementations, the instructions when executed are further operable to cause the one or more processors to perform operations comprising mapping user interaction with one or more input devices associated with the second modality to one or more two-dimensional user interface elements associated with the first modality. In some implementations, the instructions when executed are further operable to cause the one or more processors to perform operations comprising adapting one or more background elements in a three-dimensional scene associated with the second modality based on a device type associated with the second modality. In some implementations, the instructions when executed are further operable to cause the one or more processors to perform operations comprising adapting at least one target object in a three-dimensional scene associated with the second modality based on a device type associated with the second modality.

In some implementations, a computer-implemented method includes: obtaining functionality developed for a first modality of a virtual environment; mapping the functionality to a second modality of the virtual environment; and executing the functionality developed for the first modality based on user interaction associated with the second modality.

With further regard to the method, in some implementations, the first modality is associated with augmented reality of a first device type, wherein the first device type is a mobile device, wherein the second modality is associated with a second device type, and wherein the second device type is one of an augmented reality headset, a virtual reality headset, or a desktop computer. In some implementations, the method further includes: determining a device associated with the second modality; activating software modules associated with the second modality; and adapting user interaction with the device to the functionality developed for the first modality. In some implementations, the method further includes mapping one or more user gestures in a three-dimensional scene associated with the second modality to one or more two-dimensional user interface elements associated with the first modality. In some implementations, the method further includes mapping user interaction with one or more input devices associated with the second modality to one or more two-dimensional user interface elements associated with the first modality. In some implementations, the method further includes adapting one or more background elements in a three-dimensional scene associated with the second modality based on a device type associated with the second modality.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example environment associated with a system for metaverse content modality mapping, which may be used for implementations described herein.

FIG. 2 is an example flow diagram for adapting web-based augmented reality applications to deploy in a metaverse environment containing mobile phones, augmented reality headsets, virtual reality headsets, and desktop computers, according to some implementations.

FIG. 3 is an example flow diagram for deploying metaverse content or applications across different modalities in a metaverse environment, according to some implementations.

FIG. 4 is an example flow diagram for providing spatialized user interfaces (UIs) in deploying an augmented reality application across different modalities in a metaverse environment, according to some implementations.

FIG. 5 is an example flow diagram for deploying an augmented reality application in a metaverse environment involving interaction mapping of a desktop computer to a mobile device, according to some implementations.

FIG. 6 is an example flow diagram for deploying an augmented reality application in a metaverse environment involving interaction mapping of a headset to a mobile device, according to some implementations.

FIG. 7 illustrates a block diagram showing a side-view of three-dimensional (3D) rays intersecting an object such as table 702, according to some implementations.

FIG. 8 illustrates a block diagram showing a perspective-view of a 3D ray intersection point intersecting an object such as a table, according to some implementations.

FIG. 9 is an example flow diagram for adapting appropriate background elements in a 3D scene based on the device type associated with the modality, according to some implementations.

FIG. 10 is an example flow diagram for providing a responsive scale to virtual content in a 3D scene in a metaverse environment based on the device type associated with the modality, according to some implementations.

FIG. 11 illustrates a block diagram showing a side-view of a user viewing a target object on the ground where the user is using an augmented reality (AR) headset in a standing position, according to some implementations.

FIG. 12 illustrates a block diagram showing a side-view of a user viewing a target object on the ground where the user is using an AR headset in a seated position, according to some implementations.

FIG. 13 illustrates a block diagram showing a side-view of a user viewing a target object on a table where the user is using a mobile device in a standing position, according to some implementations.

FIG. 14 illustrates a block diagram showing a perspective-view through a viewer 1400 representing a view of a target object in different modalities, according to some implementations.

FIG. 15 is a block diagram of an example network environment, which may be used for some implementations described herein.

FIG. 16 is a block diagram of an example computer system, which may be used for some implementations described herein.

### DETAILED DESCRIPTION

Implementations generally relate to metaverse content modality mapping. In various implementations, a system obtains functionality developed for a primary or first modality of a metaverse environment. The first modality may involve a mobile device such as a smart phone or tablet device. The system maps the functionality to a secondary or second modality of the metaverse environment. The second modality may involve an augmented reality (AR) headset, a virtual reality (VR) headset, or a desktop computer. The system executes the functionality developed for the first modality based on user interaction associated with the second modality.

Implementations of the metaverse content modality mapping equip developers with the tools for creating content and applications for the next iteration of the internet - the metaverse. Implementations provide a powerful platform that enables developers to take advantage of metaversal deployment and is fully optimized to adapt to a myriad of devices to serve up the appropriate immersive experience every time. This is beneficial as the web evolves and becomes spatial and more immersive.

Implementations enable developers to build a web-based augmented reality (WebAR) project once and deploy it everywhere, including on iOS and Android smartphones, tablets, desktop and laptop computers, and virtual reality and augmented reality head-worn devices. Implementations enable WebAR projects to be immediately accessed on the devices that have become an integral part of people’s daily lives today, as well as the devices that will facilitate our lives in the metaverse of tomorrow - all without increasing development time.

Implementations described herein enable end users who access WebAR world effects experiences to engage with them on mobile devices, AR headsets, VR headsets, and desktop computers. Implementations ensure that users receive the right experience based on the device they are on, and manage all of the mappings needed for users to properly view, interact, and engage with the immersive content no matter what devices they are on.

Implementations provide the start of the new responsive web. Just like 2D websites needed to adapt from desktop to mobile devices, immersive websites need to react to the different devices that are used to experience them. Implementations enable developers to build WebAR experiences that are instantly compatible across the most popular mobile, head-worn devices, and desktop computers.

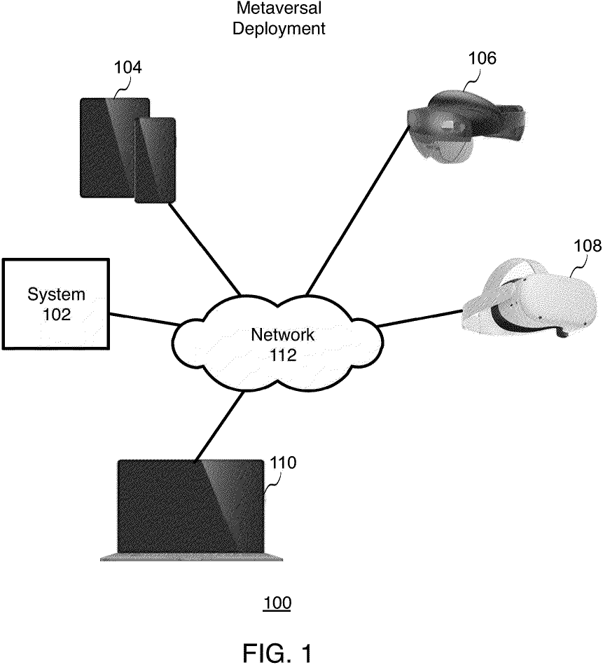

FIG. 1 is a block diagram of an example environment 100 associated with a system for metaverse content modality mapping, which may be used for implementations described herein. In various implementations, environment 100 includes a system 102, a mobile device 104, an AR headset 106, a VR headset 108, and a desktop computer 110.

In various implementations, mobile device 104 may be any suitable smart device that has a touchscreen user interface (UI). For example, mobile device 104 may be a smart phone, tablet, etc. AR headset 106 and VR headset 108 may be any suitable headset systems having a head-mounted display such as goggles, glasses, etc. with one or more display screens in front of the eyes of a user.

In various implementations, the desktop computer may be any type of computer system that is typically used on a desktop. For example, the desktop computer may be a laptop computer or a conventional desktop computer having a computer chassis, a monitor, a keyboard, and a mouse and/or trackpad. The actual configuration of the desktop computer may vary depending on the particular implementation. For example, the desktop computer may be a monitor having an integrated computer, a keyboard, and a mouse and/or trackpad.

Mobile device 104, AR headset 106, VR headset 108, and desktop computer 110 may communicate with system 102 and/or may communicate with each other directly or via system 102. Network environment 100 also includes a network 112 through which system 102 and client devices 104, 106, 108, and 110 communicate. Network 112 may be any suitable communication network such as a Bluetooth network, a Wi-Fi network, the internet, etc., or a combination thereof.

As described in more detail herein, system 102 obtains functionality developed for a primary or first modality of the metaverse environment. In various implementations, the first modality is associated with web-based AR of a first device type. The first device type may be a mobile device such as a mobile device 104 (e.g., smart phone, tablet, etc.). While various implementations are described herein in the context of a web-based AR, implementations may also be applied to native AR applications on various client devices. The system maps the functionality to a secondary or second modality of the metaverse environment. The system executes the functionality developed for the first modality based on user interaction associated with the second modality. In various implementations, the second modality is associated with a second device type that is different from the first device type. As described in more detail herein, the second device type may one of several types of devices. For example, in some implementations, the second device type may be an AR headset such as AR headset 106. In some implementations, the second device type is a VR headset such as VR headset 108. In some implementations, the second device type is a desktop computer such as desktop computer 110.

The first and second modalities may also be referred to as interaction modalities in that they provide different modalities of interaction for users of different types of devices. For example, a user may interact with mobile device 104 via a touchscreen. A user may interact with AR headset 106 or with VR headset 108 via a hand-held controller. A user may interact with desktop computer 110 via a keyboard, a trackpad, and/or a mouse (not shown). Each of these devices may be considered different modalities or interaction modalities.

For ease of illustration, the first modality refers to a primary modality involving a mobile device such as a smart phone or tablet, and the second modality refers to a secondary modality involving one or more AR headsets, one or more VR headsets, or one or more desktop computers, or a combination thereof. Such interoperability between the first modality and the second modality enables implementations of universal or metaversal deployment described herein.

For ease of illustration, FIG. 1 shows one block for each of system 102, mobile device 104, AR headset 106, VR headset 108, and desktop computer 110. Blocks 102 - 110 may represent multiple systems, server devices, databases mobile devices, AR headsets, VR headsets, and desktop computers. In other implementations, environment 100 may not have all of the components shown and/or may have other elements including other types of elements instead of, or in addition to, those shown herein.

While system 102 performs implementations described herein, in other implementations, any suitable component or combination of components associated with system 102 or any suitable processor or processors associated with system 102 may facilitate performing the implementations described herein.

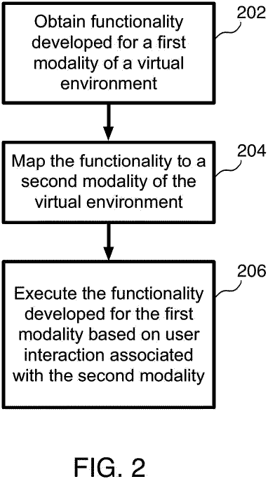

FIG. 2 is an example flow diagram for adapting web-based augmented reality applications to deploy in a metaverse environment containing mobile phones, augmented reality headsets, virtual reality headsets, and desktop computers, according to some implementations. Referring to both FIGS. 1 and 2, a method is initiated at block 202, where a system such as system 102 obtains functionality developed for a primary or first modality of a metaverse environment. As indicated above, in various implementations, the first modality is associated with a web-based AR of a first device type, which may be a mobile device such as a mobile device 104 (e.g., smart phone, tablet, etc.). Also, as indicated above, while various implementations are described herein in the context of web-based AR, implementations may also be applied to native AR applications on various client devices.

At block 204, the system maps the functionality to a secondary or second modality of the metaverse environment. As indicated above, in various implementations, the second modality is associated with a second device type that is different from the first device type. As described in more detail herein, the second device type may be one of several types of devices. For example, in various implementations, the second device type may be an AR headset such as AR headset 106, a VR headset such as VR headset 108, or a desktop computer such as desktop computer 110. Implementations described herein may apply to any of these types of client devices, or a combination thereof.

At block 206, the system executes the functionality developed for the first modality based on user interaction associated with the second modality. Various example implementations involving the system executing functionality developed for the first modality based on user interaction associated with a second modality are described in more detail herein.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

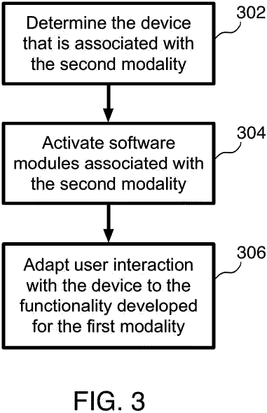

FIG. 3 is an example flow diagram for deploying metaverse content or applications across different modalities in a metaverse environment, according to some implementations. Referring to both FIGS. 1 and 3, a method is initiated at block 302, where a system such as system 102 determines the device that is associated with the second modality. The system makes this determination at run time as the connection between the system and the client device is being established. Upon detection of the device, the system determines the type of the device and its associated runtime environment or second modality (e.g., AR headset, VR headset, desktop computer, etc.). Based on the runtime environment, the system loads the correct interaction mapping library for the given modality. The interaction mapping library contains available software modules for the modality.

At block 304, the system activates appropriate software modules associated with the second modality. The system also ensures that software modules that should be running are activated by default. For example, if an immersive modality involving an AR headset or VR headset is used, the system ensures that required software modules, and associated drivers and application programming interface (APIs) are available in the browser. In various implementations, the system determines if each software module and associated drivers can power and/or run on a particular modality based on the device type (e.g., AR headset, VR headset, desktop computer, etc.).

The system also ensures that software modules that are not supported by the device of the second modality are disabled. For example, some pieces of code or tangential code such as face effects might not run properly on a particular type of device such as a device that has no camera. As such, the system may disable a software module or a portion of the software module associated with the code. The system suggests particular modalities be used instead as needed.

At block 306, the system adapts user interaction with the device (e.g., AR headset, VR headset, desktop computer, etc.) of the second modality to the functionality developed for the mobile device (e.g., smart phone, tablet device, etc.) of the first modality. In various implementations, the appropriate activated software modules and associated driver provide startup procedures, per-frame updates, and shutdown procedures of the device of the second modality. For example, with mobile phone AR, the system uses the appropriate software module to start the camera, provide frame updates, and stop the camera at the end of the session. With a VR or AR headset, the system uses the appropriate software module, starts the VR or AR session, provides head pose & controller data and updates, and stops the VR or AR session when over. With a desktop computer, the system uses the appropriate software module to display 3D content, maps a keyboard and/or trackpad and/or mouse of the second modality to 2D touches of the first modality, and hides 3D content at the end of the session.

In various implementations, the system utilizes software modules developed using WebAssembly and Web Graphics Library (WebGL), and Javascript APIs adapted to each unique device type at runtime. Implementations provide a best-in-class mobile WebAR experience using a camera application framework, yet gracefully integrate with the WebXR API to provide an intelligent wrapper that optimizes WebAR projects for non-mobile devices such as an AR or VR headset, or a computer, etc. As described in various implementations herein, implementations optimize WebAR projects by selecting an appropriate combination of technologies to run the experience, to provide UX compatibility mapping through modality specific mechanisms, to construct or hide virtual environments, and to spatialize 2D interfaces, etc.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

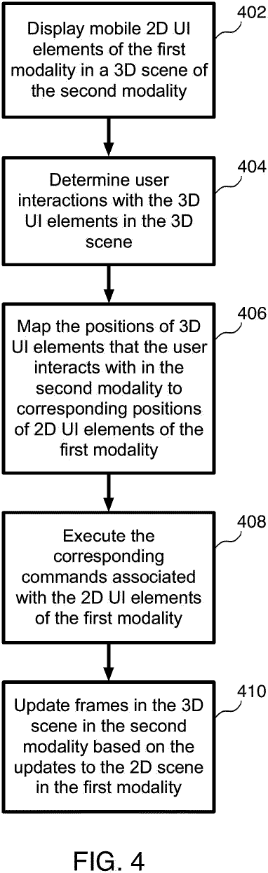

FIG. 4 is an example flow diagram for providing spatialized UIs in deploying an augmented reality application across different modalities in a metaverse environment, according to some implementations. In various implementations, the system maps one or more user gestures associated with a spatialized UI in a 3D scene in a second modality to one or more 2D UI elements associated with the first modality. As described in more detail below, the system translates interactive 2D UI elements originally designed for a mobile device in the first modality onto a spatial control panel in a second modality when a virtual experience is accessed on an AR headset or a VR headset.

Referring to both FIGS. 1 and 4, a method is initiated at block 402, where a system such as system 102 displays mobile 2D UI elements of the first modality in a 3D scene of the second modality. In some implementations, the system may render the 2D UI elements from the first modality in the second UI of the second modality. For example, the system may determine what 2D UI elements (e.g., buttons, etc.) have been drawn on the 2D screen. The system may then capture 2D UI elements and convert the 2D UI elements to corresponding 3D UI element versions that the system displays in the 3D scene. Such 3D UI elements are functional in that the user may select and interact with the 3D UI elements in the second modality as if the user were selecting and interacting with 2D UI elements in the first modality.

In some implementations, the system may recreate the 2D UI elements as 3D UI elements directly in the 3D scene of the second modality. In some scenarios, being translated from an intended 2D UI element may result in a corresponding 3D UI element being skewed in the 3D environment. As such, in some implementations, the system may also create an optimized layout of the corresponding 3D UI elements in the 3D scene of the second modality.

At block 404, the system determines user interactions with the 3D UI elements in the 3D scene. These user interactions may be referred to as trigger events. In various implementations, the system determines the location of 3D UI elements in the 3D scene that the user interacts with. The system also determines the type of user interaction with each 3D UI element and information (e.g., vectors, values, etc.) associated with each user interaction. For example, the system may detect virtual control selections and the dragging of virtual objects such as when the user selects and manipulates a given virtual object. In another example, the system may determine when the user selects a given virtual object and modifies the virtual object (e.g., changes the size, color, etc.). The system may also determine user interaction with other various types of virtual controls (e.g., clicking a button for exiting the AR or VR environment, etc.).

At block 406, the system maps the positions of 3D UI elements that the user interacts with in the second modality to corresponding positions of 2D UI elements of the first modality or directly to 2D UI elements directly. For example, if the user clicks on a given virtual control (e.g., button, etc.) on a screen in the 3D scene of the second modality, the system maps that trigger event to a “tap” at the corresponding position of the virtual control (e.g., button, etc.) on the 2D screen of the first modality (e.g., on the 2D screen of a mobile device), or maps that trigger event directly to the corresponding control object rendered on the 2D screen. In other words, the system translates trigger event gestures such as a button click in the second modality to a button tap in the first modality. In this example scenario, the system may detect and identify a user click on the virtual control based on the user physically pressing a button on a hand-held controller in an AR or VR headset scenario, where the position of the hand-held controller maps to the virtual button rendered in the 3D scene. The system then wave traces or propagates the trigger event in the second modality to the corresponding 2D UI element in the first modality.

In block 408, the system executes the corresponding commands associated with the 2D UI elements of the first modality.

At block 410, the system updates frames in the 3D scene in the second modality based on the updates to the 2D scene in the first modality. As a result, the user experiences interactions in the 3D scene in the second modality seamlessly while operations are executed in the first modality.

While 3D content is present in many AR experiences, the majority of WebAR projects also include a number of 2D UI elements. As exemplified above, 2D elements such as buttons or text help facilitate user interactions. These 2D elements are ideal for flat screens such as smartphones, tablets, and desktop computers. Implementations described herein provide special attention when made available in AR and VR headsets where the experience becomes spatial. 3D elements on a virtual spatial control panel with 3D UI elements in a 3D scene may be referred to as a document object model (DOM) tablet. In various implementations, the DOM tablet facilitates user interactions such as engaging with buttons to influence the 3D scene. In some implementations, the system may enable a DOM Tablet to be repositioned by the user or minimized on the user’s wrist when not required so as to not interfere with the user’s immersive experience.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

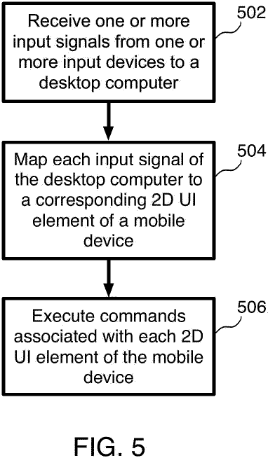

FIG. 5 is an example flow diagram for deploying an augmented reality application in a metaverse environment involving interaction mapping of a desktop computer to a mobile device, according to some implementations. As described in more detail below, in various implementations, the system maps user interaction with one or more input devices to a desktop computer associated with the second modality to one or more 2D UI elements of a mobile device associated with the first modality.

Referring to both FIGS. 1 and 5, a method is initiated at block 502, where a system such as system 102 receives input signals from one or more input devices to a desktop computer. As indicated above, in various implementations, the desktop computer may be any type of computer system that is typically used on a desktop such as a laptop computer or a conventional desktop computer having a computer chassis, a monitor, a keyboard, and a mouse and/or trackpad, etc. In various implementations, the input devices are mechanical input devices and the specific input device type may vary, depending on the particular implementation. For example, the input devices may include keyboards, mice, trackpads, joysticks, game controllers, etc.

At block 504, the system maps each input signal of the desktop computer to a corresponding 2D UI element of a mobile device. As indicated herein, the mobile device is a primary or first modality in a metaverse environment and the desktop computer is a secondary or second modality in the metaverse environment. An example input signal to 2D UI element mapping may be a point, click, and drag gesture or scroll gesture on an object shown on a desktop computer monitor being mapped to a pinch gesture or other multitouch gesture on the same object on a mobile phone. The particular combination of input signals and mapping to corresponding 2D UI elements may vary, depending on the particular implementation. In another example, input signals may be based on a scroll gesture for changing the scale of an object shown on a desktop computer monitor, where the system maps the scroll gesture to a multitouch pinch gesture on the same object on the mobile phone. In another example, input signals may be based on an option being selected via a keyboard and a click and drag gesture to drag an object shown on a desktop computer monitor, where the system maps this set of signals to a two-finger touch gesture on the same object on the mobile phone.

While some implementations are described in the context of 2D UI elements shown on a screen of a mobile device, these implementations may also apply to movements of the mobile phone. For example, input signals may be based on a right-click and drag on an object shown on a desktop computer monitor for rotating the object, where the system maps this set of signals to a movement of a mobile phone, where the phone movement corresponds to a rotation of the object or movement around an object. In another example, input signals may be based on the pressing of arrow keys on a keyboard for x-y translation of an object shown on a desktop computer monitor, where the system maps this set of signals to x-y translation of the object on the screen of a mobile phone.

At block 506, the system executes commands associated with each 2D UI element of the mobile device. In various implementations, execution of the commands results in various manipulations of one or more target objects on the screen of the mobile device such as those described in the previous examples. As a result, the system translates input signals from input devices of the second modality (e.g., desktop computer) to 2D UI elements on the first modality (e.g., mobile device).

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

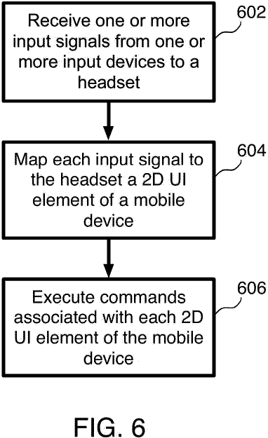

FIG. 6 is an example flow diagram for deploying an augmented reality application in a metaverse environment involving interaction mapping of a headset to a mobile device, according to some implementations. As described in more detail below, in various implementations, the system maps user interaction with one or more input devices to a headset associated with the second modality to one or more 2D UI elements of a mobile device associated with the first modality.

Referring to both FIGS. 1 and 6, a method is initiated at block 602, where a system such as system 102 receives input signals from one or more input devices to a headset. In various implementations, the headset may be an AR headset or a VR headset, such as AR headset 106 or VR headset 108 of FIG. 1. As indicated above, an AR headset or a VR headset may be any suitable headset systems having a head-mounted display such as goggles, glasses, etc. with one or more display screens in front of the eyes of a user. In various implementations, the input devices may include mechanical input devices and the specific input device type may vary, depending on the particular implementation. For example, the input devices may include game controllers, eye tracking devices, etc. Example input signals may include detection and tracking of a ray intersection associated with the headset and a user interaction of a hand-held controller.

At block 604, the system maps each input signal to the headset to a corresponding 2D UI element of a mobile device. Input signals to the headset may include, for example, control signals from a hand-held controller, input from a gaze tracker, 3D ray intersection data, etc. As indicated herein, the mobile device is a first modality in a metaverse environment and the headset is a second modality in the metaverse environment. In some implementations, the system may map detection and tracking of a 3D ray intersection associated with the headset and user interaction with a hand-held controller to a 2D touch coordinates on a mobile device.

At block 606, the system executes commands associated with each 2D UI element of the mobile device. In various implementations, execution of the commands results in various manipulations of one or more target objects on the screen of the mobile device such as those described in the previous examples. As a result, the system translates input signals from input devices of the second modality (e.g., headset) to 2D UI elements on the first modality (e.g., mobile device).

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

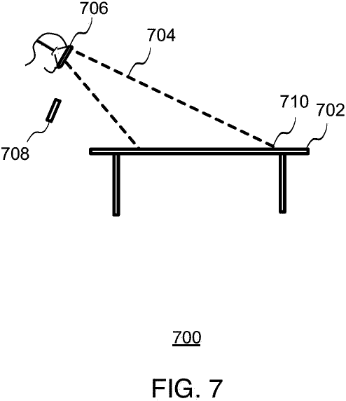

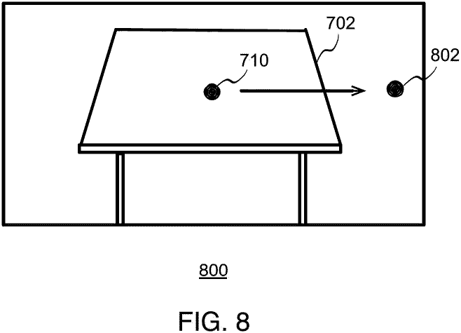

FIG. 7 illustrates a block diagram showing a side-view 700 of 3D rays intersecting an object such as table 702, according to some implementations. Shown are a table 702, a 3D ray 704 associated with an AR headset 706, and a hand-held controller 708. In some implementations, in the context of AR headset 706, the system may determine and track 3D ray 704 based on a camera or pair of cameras of AR headset 706 that capture a view of the real world. The camera or cameras correspond to the eyes of the user (not shown). In some implementations, 3D ray 704 intersects table 702 at 3D ray intersection point 710. In some implementations, 3D ray 704 may also be based on a camera or pair of cameras of AR headset 706 that captures the gaze of the user’s eyes (e.g., line of sight) of table 702. The actual technique for determining the direction of 3D ray 704 and the location of the 3D ray intersection point 710 may vary, depending on the particular implementation. In some implementations, the system may display 3D ray intersection point 710 in AR headset 706, as described in more detail below in connection with FIG. 8.

FIG. 8 illustrates a block diagram showing a perspective-view 800 of 3D ray intersection point 710 intersecting an object such as table 702 of FIG. 7, according to some implementations. Shown are a table 702, 3D ray intersection point 710, and a 3D ray intersection point 802. In various implementations, perspective-view 800 may represent the visual view that the user sees out of AR headset 706 (shown in FIG. 7). As shown, the system may display 3D ray intersection point 710 in the visual view of the viewer of AR headset 706.

In a scenario where either AR headset and/or the gaze (e.g., line of sight) of the user moves laterally such that the 3D ray moves laterally, the 3D ray intersection point shifts from 3D ray intersection point 710 on table 702 to 3D ray intersection point 802, which is on the ground beside the table. In various implementations, the system smooths the motion of the 3D ray intersection point so as to maintain smooth continuity from the transition of the 3D ray intersection point from table to the floor or ground. In some implementations, the system determines a reference point or anchor point at 3D ray intersection point 802 where the 3D ray initially intersects table 702. The system continues to smoothly update the 3D ray intersection point while being dragged laterally, which prevents the 3D ray intersection point from making a rapid movement from table 702 to the floor.

In various implementations, the system determines a user selection of table 702 in the 3D scene of the second modality in combination with a user interaction of a hand-held controller, where the system maps a combination of these input signals to a 2D UI element (e.g., 2D coordinates) of the first modality. For example, the system may enable the user to select an object such as table 702 by clicking on hand-held controller 708 as the 3D ray intersection point is at table 702. This enables the user to point to a particular object such a table 702 based on 3D ray intersection point 710. As long as the user maintains the selection (e.g., continues pressing a button on hand-held controller 708), the system may lock 3D ray intersection point 710 on table 702. If table 702 is a virtual object, the system may enable the user to move and drag table 702 around in the 3D scene while table 702 is selected.

In some implementations, in the context of a VR headset (not shown), the 3D ray intersection may be based on a camera or pair of cameras of the VR headset that captures the gaze of the user’s eyes (e.g., line of sight) of objects in the virtual 3D scene. The camera or cameras tracking the gaze of the user also correspond to the eyes of the user.

In both scenarios, whether the headset is AR headset 707 or a VR headset (not shown), the system maps the 3D ray intersections of the 3D scene of the second modality to 2D touches on the screen of a mobile phone of the first modality. The system also enables the user to select a given object and manipulate the object based on user interaction with a hand-held controller. In other words, user interactions with the headset and controller result in a “tap” on a target point in the 3D space (e.g., 3D ray intersection point 710), which translates to a tap on a target point on the touchscreen of a mobile device.

Referring again to FIG. 6, at block 606, the system executes commands associated with each 2D UI element of the mobile device. In various implementations, execution of the commands results in various manipulations (e.g., touches, taps, drags, etc.) of one or more target objects on the screen of the mobile device such as those described in the previous examples. As a result, the system translates input signals from input devices of the second modality (e.g., AR or VR headset) to 2D UI elements on the first modality (e.g., mobile device). Accordingly, the system translates the functionality of a headset and hand-held controller (e.g., button selection, etc.) to touches and drag gestures on a mobile device.

Conventionally, to engage with AR on mobile devices, users are often asked to perform a number of gestures such as tapping, pinching, and swiping on the screen of the mobile device, etc. Benefits of implementations described herein involving metaversal deployment make the AR experience available on non-mobile devices based in part on interaction mapping for these new device categories or second modalities as described herein. To achieve these benefits, implementations spatialize mobile WebAR touch inputs by mapping these to a multitude of input options available across AR and VR headsets, desktop computers and associated input devices including keyboards, touchpads, mice, controllers, hand tracking, etc. As the device that the user is on will be identified at runtime, implementations serve up the appropriate interactions for the user, handling interaction mappings to allowing the user to intuitively interact with 3D content.

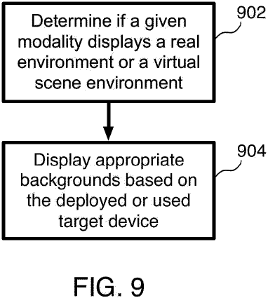

FIG. 9 is an example flow diagram for adapting appropriate background elements in a 3D scene based on the device type associated with the modality, according to some implementations. As described in more detail below, the system detects the modality used and whether the experience has an appropriate environment in the 3D scene. The system performs environmental mapping to enhance the metaversal experience across different modalities. In various implementations, the system adapts one or more background elements in a 3D scene associated with the second modality based on a device type associated with the second modality.

In various implementations, a method is initiated at block 902, where a system such as system 102 of FIG. 1 determines if a given modality displays a real environment or a virtual scene environment. For example, AR headsets and mobile devices with cameras display real environments but do not display virtual scene environments. VR headsets and desktop computers display virtual scene environments but do not display real environments.

At block 904, the system displays appropriate backgrounds based on the deployed or used target device. As indicated above, AR headsets and mobile devices with cameras display real environments but do not display virtual scene environments. In the scenario where an AR headset or mobile device is used, the system may simply display the real environment as captured by the camera of the respective device. If the AR headset or mobile device has a scene environment displayed, the system may simply remove the virtual scene environment in order to enable the real environment to be fully visible, as the virtual scene environment is not needed.

As indicated above, VR headsets and desktop computers display virtual scene environments but do not display real environments. In a scenario where a VR headset or desktop computer is used, the system may continue to display the virtual environment. If the VR headset or desktop computer does not already display a virtual environment, the system adds appropriate background elements to the 3D scene. For example, the system may generate and display a floor or ground to provide a sense of relative vertical depth between a given virtual object (e.g., a virtual car) and the floor or ground. Without a floor, there would be no sense of scale for a virtual object such as an embodied car, which may appear to be floating in a blank space. In another example, the system may generate and display fog on the horizon to provide a sense of horizontal or lateral depth between the virtual object and the horizon.

In various implementations, the system may add a pattern to the floor. This enables the user to see movement of an object such as a car as the object moves in the 3D scene. The pattern on the floor appearing to shift would give the user an indication that the object is moving across the floor. The system may provide any added floor with a pattern or a background such a fog on the horizon as a default. The fog may prevent the user from seeing an infinite distance in order to provide a sense of distance. In some implementations, the system may also provide scene elements such as a tree or mountain by default in order to provide a sense of scale, as well as distance. In some implementations, the system may add color changes to further provide a sense of depth. For example, the system may make more distant portions of the floor or more distant objects a different color (e.g., more blue-gray in hue, etc.).

In various implementations, the system enables a developer or user to add a custom background with any desired elements with color, patterns, and a variety of shapes, including a ground or terrain, buildings, trees, clouds, etc. to enhance the overall experience. The system may also enable a developer or user to provide walls in order to place the 3D scene indoors. As such, the 3D scene canvas may be outdoors or indoors or include both outdoor and indoor environments.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

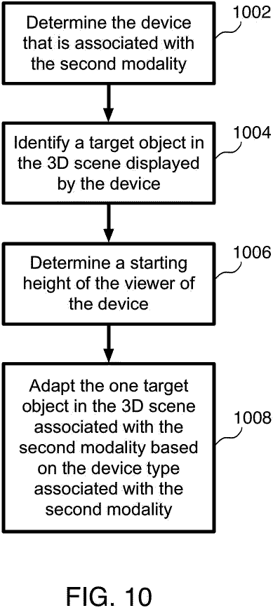

FIG. 10 is an example flow diagram for providing a responsive scale to virtual content in a 3D scene in a metaverse environment based on the device type associated with the modality, according to some implementations. As described in more detail below, the system adapts a target object in a 3D scene in order to accommodate the user position by making 3D content comfortable and accessible while ensuring that a developer’s vision of the 3D scene is consistent across devices of different modalities.

In various implementations, a method is initiated at block 1002, where a system such as system 102 of FIG. 1 determines the device type of a second modality being used in a metaverse environment. For example, the system may determine if the device is an AR headset, a VR headset, a desktop computer, etc.

At block 1004, the system identifies a target object in the 3D scene displayed by the device.

At block 1006, the system determines a starting height of the viewer of the device. In some implementations, the starting height may be the height of the camera relative to the ground. The starting height represents the visual view that user has of the target object when the user starts looking at the target objects through the viewer.

At block 1008, the system adapts the one target object in the 3D scene associated with the second modality based on the device type associated with the second modality. For example, the system scales the target object up or down to fill a consistent visual angle and visual comfort across devices of different modalities. This enables the starting position of the target object in 3D scenes to remain the same or approximately the same in size or scale across headsets, desktops, and mobile phones, and scenarios. In some implementations, as an alternative to scaling objects in the scene, other implementations may change the height of the virtual camera and scale subsequent camera motions accordingly. In various implementations, the system may also adjust the viewing angle of the target object in order to make the target object appear the same or similar with different devices or modalities or scenarios. Accordingly, implementations ensure that the content of the 3D scene including the target object is visually comfortable and accessible across devices of different modalities and user scenarios. Also, there is no need for the user to navigate the scene in order to make the view comfortable.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

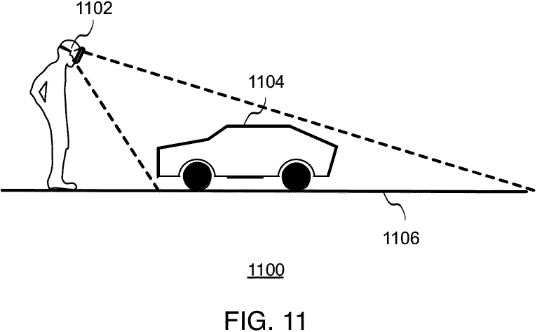

The following FIGS. 11, 12, and 13, show different views of a target object viewed at different heights and with different modalities.

FIG. 11 illustrates a block diagram showing a side-view 1100 of a user viewing a target object on the ground where the user is using an AR headset in a standing position, according to some implementations. Shown is an AR headset 1102, a target object 1104, and the ground 1106. In this scenario, the user is standing and looking toward ground 1106. Also, target object 1104 is a virtual car. In various implementations, the system adapts target object 1104 such that the user views the entire target object 1104 through an AR headset 1102.

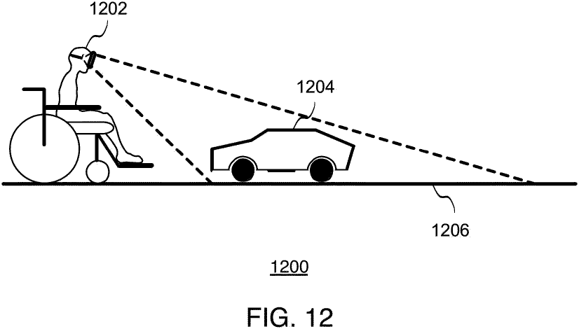

FIG. 12 illustrates a block diagram showing a side-view 1200 of a user viewing a target object on the ground where the user is using an AR headset in a seated position, according to some implementations. Shown is an AR headset 1202, a target object 1204, which is a car, and the ground 1206. In this scenario, the user is seated and looking toward ground 1206. The user may be seated in a chair, a wheelchair, etc. Also, target object 1204 is a virtual car. In various implementations, the system adapts target object 1204 such that the user views entire target object 1204 through AR headset 1202. This provides a user with limited mobility with accessibility to a full immersion experience.

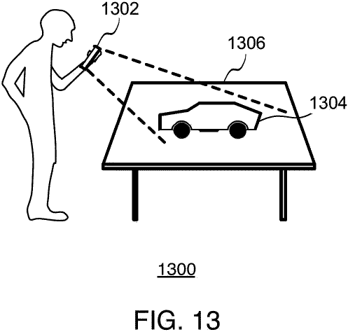

FIG. 13 illustrates a block diagram showing a side-view 1300 of a user viewing a target object on a table where the user is using a mobile device in a standing position, according to some implementations. Shown is a mobile device 1302, a target object 1304, which is a car, and a table 1306. In this scenario, the user is standing and looking toward table 1306. Also, target object 1304 is a virtual car. In various implementations, the system adapts target object 1304 such that the user views entire target object 1304 through mobile device 1302.

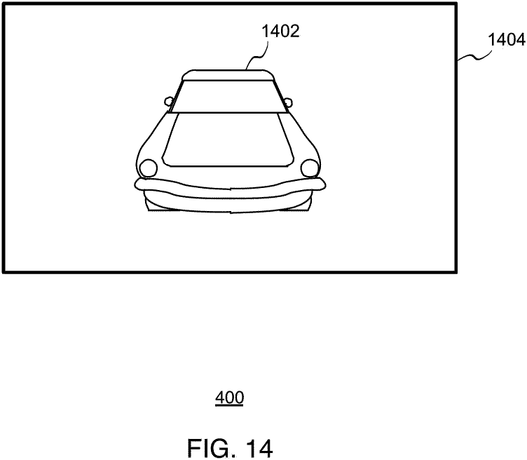

FIG. 14 illustrates a block diagram showing a perspective-view through a viewer 1400 representing a view of a target object in different modalities, according to some implementations. Shown is a target object 1402, which is a car, being viewed in a display 1404 of a viewer. In various implementations, target object 1402 is shown as taking a certain portion of the display, where the entire target object 1402 is visible. As indicated above, in various implementations, the system may also adjust the viewing angle of the target object in order to make the target object appear the same or similar with different devices or modalities or scenarios. This view of target object 1402 may represent the view of target object in any of the scenarios of FIGS. 11, 12, and 13 based on adjustments to the scale of target object 1402 to the type of device being used. As a result, the target object covers the same amount of the field of view in the different scenarios and modalities.

Accordingly, implementations are beneficial in that they account for not only the type of device, but also the user’s position while engaging with the 3D experience. This applies to whether the user is standing or sitting in virtual reality. Implementations dynamically adjust the viewing height in order to ensure that all content viewed is comfortable and accessible regardless of what device the user is using. Implementations achieve these benefits while respecting the initial vision point of view so as to increase the confidence that the user is viewing the content the way it was intended by the developer.

Implementations have various other benefits. For example, while implementations eliminate or minimize much work out of cross-platform development, implementations include powerful mechanisms as part of the platform that help with customization of the 3D experience per device category. Implementations have full support for WebAR world effects created using three.js and A-Frame. Implementation’s metaversal deployment capabilities are also optimized for iOS and Android smartphones and tablets, desktop and laptop computers, and various AR and VR headset systems. Implementations enable developers to create a variety of mobile-only WebAR world effects, face effects, and image target experiences.

Implementations make the web a powerful place for smartphone-based AR reality and give developers access to billions of smartphones across iOS and Android devices, the widest reach of any augmented reality platform. Implementations unlock even more places to access and engage with immersive content, significantly expanding this reach without expanding the development time. Implementations of the metaversal deployment enable developers to create an WebAR project that automatically adapts from mobile devices to computers and headsets.

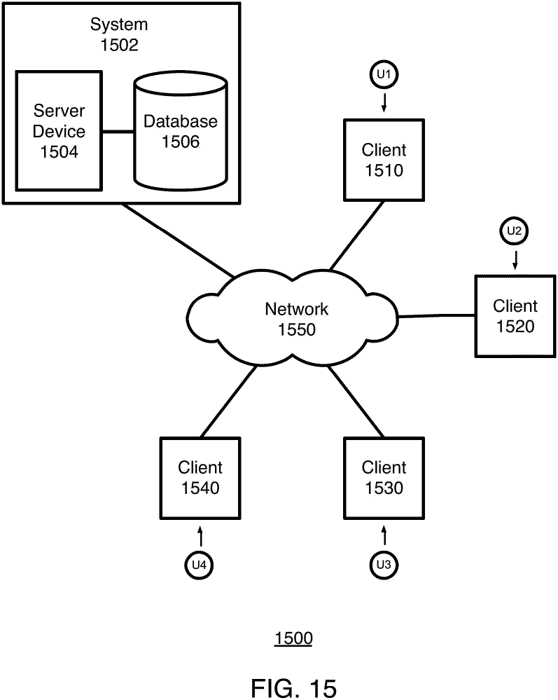

FIG. 15 is a block diagram of an example network environment 1500, which may be used for some implementations described herein. In some implementations, network environment 1500 includes a system 1502, which includes a server device 1504 and a database 1506. For example, system 1502 may be used to implement system 102 of FIG. 1, as well as to perform implementations described herein. Network environment 1500 also includes client devices 1510, 1520, 1530, and 1540, which may communicate with system 1502 and/or may communicate with each other directly or via system 1502. Network environment 1500 also includes a network 1550 through which system 1502 and client devices 1510, 1520, 1530, and 1540 communicate. Network 1550 may be any suitable communication network such as a Wi-Fi network, Bluetooth network, the Internet, etc.

For ease of illustration, FIG. 15 shows one block for each of system 1502, server device 1504, and network database 1506, and shows four blocks for client devices 1510, 1520, 1530, and 1540. Blocks 1502, 1504, and 1506 may represent multiple systems, server devices, and network databases. Also, there may be any number of client devices. In other implementations, environment 1500 may not have all of the components shown and/or may have other elements including other types of elements instead of, or in addition to, those shown herein.

While server device 1504 of system 1502 performs implementations described herein, in other implementations, any suitable component or combination of components associated with system 1502 or any suitable processor or processors associated with system 1502 may facilitate performing the implementations described herein.

In the various implementations described herein, a processor of system 1502 and/or a processor of any client device 1510, 1520, 1530, and 1540 cause the elements described herein (e.g., information, etc.) to be displayed in a user interface on one or more display screens.

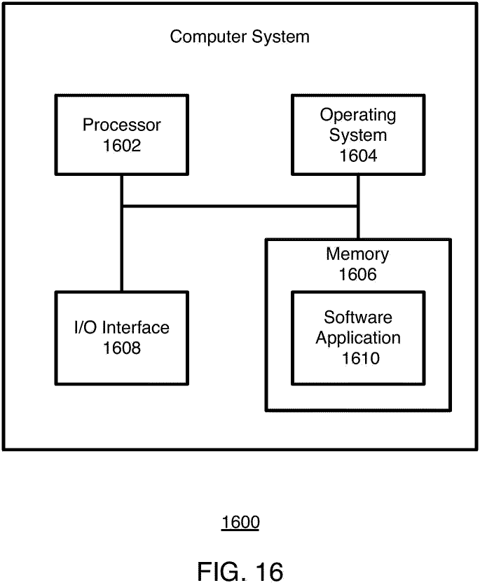

FIG. 16 is a block diagram of an example computer system 1600, which may be used for some implementations described herein. For example, computer system 1600 may be used to implement server device 1504 of FIG. 15 and/or system 102 of FIG. 1, as well as to perform implementations described herein. In some implementations, computer system 1600 may include a processor 1602, an operating system 1604, a memory 1606, and an input/output (I/O) interface 1608. In various implementations, processor 1602 may be used to implement various functions and features described herein, as well as to perform the method implementations described herein. While processor 1602 is described as performing implementations described herein, any suitable component or combination of components of computer system 1600 or any suitable processor or processors associated with computer system 1600 or any suitable system may perform the steps described. Implementations described herein may be carried out on a user device, on a server, or a combination of both.

Computer system 1600 also includes a software application 1610, which may be stored on memory 1606 or on any other suitable storage location or computer-readable medium. Software application 1610 provides instructions that enable processor 1602 to perform the implementations described herein and other functions. Software application may also include an engine such as a network engine for performing various functions associated with one or more networks and network communications. The components of computer system 1600 may be implemented by one or more processors or any combination of hardware devices, as well as any combination of hardware, software, firmware, etc.

For ease of illustration, FIG. 16 shows one block for each of processor 1602, operating system 1604, memory 1606, I/O interface 1608, and software application 1610. These blocks 1602, 1604, 1606, 1608, and 1610 may represent multiple processors, operating systems, memories, I/O interfaces, and software applications. In various implementations, computer system 1600 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors;
logic encoded in one or more non-transitory computer-readable storage media for execution by the one or more processors and when executed operable to perform operations comprising:
obtaining functionality developed for a first modality of a virtual environment;
mapping the functionality to a second modality of the virtual environment; and
executing the functionality developed for the first modality based on user interaction associated with the second modality.

2. The system of claim 1, wherein the first modality is associated with augmented reality of a first device type, wherein the first device type is a mobile device, wherein the second modality is associated with a second device type, and wherein the second device type is one of an augmented reality headset, a virtual reality headset, or a desktop computer.

3. The system of claim 1, wherein the logic when executed is further operable to cause the one or more processors to perform operations comprising:
determining a device associated with the second modality;
activating software modules associated with the second modality; and
adapting user interaction with the device to the functionality developed for the first modality.

4. The system of claim 1, wherein the logic when executed is further operable to cause the one or more processors to perform operations comprising mapping one or more user gestures in a three-dimensional scene associated with the second modality to one or more two-dimensional user interface elements associated with the first modality.

5. The system of claim 1, wherein the logic when executed is further operable to cause the one or more processors to perform operations comprising mapping user interaction with one or more input devices associated with the second modality to one or more two-dimensional user interface elements associated with the first modality.

6. The system of claim 1, wherein the logic when executed is further operable to cause the one or more processors to perform operations comprising adapting one or more background elements in a three-dimensional scene associated with the second modality based on a device type associated with the second modality.

7. The system of claim 1, wherein the logic when executed is further operable to cause the one or more processors to perform operations comprising adapting at least one target object in a three-dimensional scene associated with the second modality based on a device type associated with the second modality.

8. A non-transitory computer-readable storage medium carrying program instructions thereon, the instructions when executed by one or more processors are operable to perform operations comprising:
obtaining functionality developed for a first modality of a virtual environment;
mapping the functionality to a second modality of the virtual environment; and
executing the functionality developed for the first modality based on user interaction associated with the second modality.

9. The computer-readable storage medium of claim 8, wherein the first modality is associated with augmented reality of a first device type, wherein the first device type is a mobile device, wherein the second modality is associated with a second device type, and wherein the second device type is one of an augmented reality headset, a virtual reality headset, or a desktop computer.

10. The computer-readable storage medium of claim 8, wherein the logic when executed is further operable to cause the one or more processors to perform operations comprising:
determining a device associated with the second modality;
activating software modules associated with the second modality; and
adapting user interaction with the device to the functionality developed for the first modality.

11. The computer-readable storage medium of claim 8, wherein the instructions when executed are further operable to cause the one or more processors to perform operations comprising mapping one or more user gestures in a three-dimensional scene associated with the second modality to one or more two-dimensional user interface elements associated with the first modality.

12. The computer-readable storage medium of claim 8, wherein the instructions when executed are further operable to cause the one or more processors to perform operations comprising mapping user interaction with one or more input devices associated with the second modality to one or more two-dimensional user interface elements associated with the first modality.

13. The computer-readable storage medium of claim 8, wherein the instructions when executed are further operable to cause the one or more processors to perform operations comprising adapting one or more background elements in a three-dimensional scene associated with the second modality based on a device type associated with the second modality.

14. The computer-readable storage medium of claim 8, wherein the instructions when executed are further operable to cause the one or more processors to perform operations comprising adapting at least one target object in a three-dimensional scene associated with the second modality based on a device type associated with the second modality.

15. A method comprising:
obtaining functionality developed for a first modality of a virtual environment;
mapping the functionality to a second modality of the virtual environment; and
executing the functionality developed for the first modality based on user interaction associated with the second modality.

16. The method of claim 15, wherein the first modality is associated with augmented reality of a first device type, wherein the first device type is a mobile device, wherein the second modality is associated with a second device type, and wherein the second device type is one of an augmented reality headset, a virtual reality headset, or a desktop computer.

17. The method of claim 15, further comprising:
determining a device associated with the second modality;
activating software modules associated with the second modality; and
adapting user interaction with the device to the functionality developed for the first modality.

18. The method of claim 15, further comprising mapping one or more user gestures in a three-dimensional scene associated with the second modality to one or more two-dimensional user interface elements associated with the first modality.

19. The method of claim 15, further comprising mapping user interaction with one or more input devices associated with the second modality to one or more two-dimensional user interface elements associated with the first modality.

20. The method of claim 15, further comprising adapting one or more background elements in a three-dimensional scene associated with the second modality based on a device type associated with the second modality.
